(19) United States
(12) Patent Application Publication
(10) Pub. No.: US 2023/0228291 A1
(43) Pub. Date: Jul. 20, 2023

(54) ROTOR FOR AN AIR SUPPLY UNIT OF A FUEL CELL UNIT, AND AIR SUPPLY UNIT FOR A FUEL CELL UNIT

(71) Applicant: CELLCENTRIC GMBH & CO. KG, Kirchheim unter Teck (DE)

(72) Inventor: Sven SKORUPA, Walddorfhäslach (DE)

(21) Appl. No.: 17/998,954

(22) PCT Filed: May 12, 2021
(86) PCT No.: PCT/EP2021/062582

§ 371 Date: Nov. 16, 2022

(30) Foreign Application Priority Data
May 18, 2020 (DE) 10 2020 002 974.4

(51) Int. Cl. F16C 17/02; F04D 25/06; F04D 25/08; F04D 29/02; F04D 29/051; F04D 29/053; F04D 29/056; H01M 8/04111

(52) U.S. Cl. CPC F16C 17/024; F04D 25/06; F04D 25/08; F04D 29/023; F04D 29/0513; F04D 29/053; F04D 29/056; H01M 8/04111; F05D 2220/40; F05D 2300/224; F05D 2300/603; F05D 2300/611

(57) ABSTRACT

The invention relates to a rotor (4) for an air supply unit (1) of a fuel cell unit, which rotor is to be rotatably mounted in a housing (5) of the air supply unit (1) by means of foil-air bearings (15, 16). According to the invention, at least portions of the rotor (4) are formed of a carbon graphite material or of a synthetic-resin-bonded carbon fiber material or coated therewith. The invention also relates to an air supply unit (1) having a rotor (4) of this type.

The invention relates to a rotor for an air supply unit of a fuel cell unit according to the features of the preamble of claim 1 and to an air supply unit for a fuel cell unit.

Air supply units for fuel cell units are generally known from the prior art. These air supply units comprise a rotor which is rotatably mounted in a housing by means of foil-air bearings in order to draw in air, compress it and introduce it into the fuel cell unit.

WO 2007/004770 A1 describes a coating material and a coating method. The coating material is applied to a rotating shaft. It comprises 20 to 40% by weight of chromium oxide, 40 to 60% by weight of a binding material, 10 to 20% by weight of tungsten disulfide and 10 to 20% by weight of silver. The binder material comprises 60 to 80% by weight of nickel and 20 to 40% by weight of chromium.

An aerodynamic air bearing and a method for the production thereof are known from DE 102014201 563 A1. For mounting a shaft, at least one corrugated foil is fixed in a bearing housing. A covering foil lies between the corrugated foil and the shaft, wherein a surface of the covering foil facing the shaft carries a coating. A partial coating of the cover foil forms a structuring in the surface facing the shaft.

The object of the invention is to specify a rotor for an air supply unit of a fuel cell unit which is improved compared to the prior art, and an air supply unit for a fuel cell unit which is improved compared to the prior art.

The object is achieved according to the invention by a rotor for an air supply unit of a fuel cell unit having the features of claim 1 and an air supply unit for a fuel cell unit having the features of claim 5.

Advantageous embodiments of the invention are the subject matter of the dependent claims.

In the case of a rotor for an air supply unit of a fuel cell unit, which rotor is to be rotatably mounted in a housing of the air supply unit, in particular by means of foil-air bearings, it is provided according to the invention that at least portions of the rotor are formed of a carbon graphite material or of a synthetic resin-bonded carbon fiber material or are coated therewith.

In particular, at least portions of a rotor shaft and/or of an axial bearing disc of the rotor are/is formed of the carbon graphite material or of the synthetic resin-bonded carbon fiber material or are coated therewith. The rotor shaft has, for example, two radial bearing portions which are formed in each case from the carbon graphite material or from the synthetic resin-bonded carbon fiber material or are coated therewith. In the case of the axial bearing disc, it can be provided, for example, that opposite bearing surfaces of the axial bearing disc are coated with the carbon graphite material or with the synthetic resin-bonded carbon fiber material, or the entire axial bearing disc is formed therefrom.

For example, a combination of one or more carbon graphite materials and/or one or more resin-bonded carbon fiber materials can also be provided for the rotor. In particular in the case of coating, it can also be provided, for example, that different bearing portions are coated with different ones of the above-mentioned materials. For example, it can be provided that the radial bearing portions and the axial bearing disc are coated with different ones of the above-mentioned materials, i.e. they have coatings differing from one another. In the case of the rotor shaft, it can be provided, for example, that all radial bearing portions are coated with the same material or with different ones of the above-mentioned materials. In the case of the axial bearing disc, it can be provided, for example, that both bearing surfaces are coated with the same material or that they are coated with different ones of abovementioned materials.

Also, in the case of the embodiment from one of the above-mentioned materials, it can be provided that the rotor shaft and the axial bearing disc are formed, in portions or entirely, from the same material or from different ones of the above-mentioned materials.

It can also be provided, for example, that the rotor shaft is formed at least in portions or entirely from one of the above-mentioned materials, and the axial bearing disc is coated at least in portions or entirely with one of the above-mentioned materials, or vice versa.

An air supply unit according to the invention for a fuel cell unit comprises such a rotor which is rotatably mounted in the housing of the air supply unit by means of foil-air bearings.

The use according to the invention of carbon graphite materials and/or resin-bonded carbon fiber materials significantly improves mixed friction properties and emergency running properties in foil-air bearings, in particular in radial bearings and axial bearings. Both these carbon graphite materials and these resin-bonded carbon fiber materials have self-lubricating properties due to their particular crystal structure. Without additional lubricants, a coefficient of friction between these materials and their friction partners is therefore comparatively small.

Due to the corresponding low friction coefficients, a material pairing of such a material with conventional metal alloys of a friction partner offers good emergency running properties. This applies in particular to foil-air bearings in which the friction partner is formed by at least one foil of the foil-air bearing. Typical metal alloys of such friction partners, in particular of foils for foil-air bearings, are, for example, steel, titanium or titanium alloys, also referred to as titanium, or nickel-based alloys having nickel as main component, chromium as important secondary component and optionally iron, molybdenum, niobium, cobalt, manganese, copper, aluminum, titanium, silicon, carbon, sulfur, phosphorus and/or boron as further secondary components. These nickel-based alloys are also referred to as Inconel. Furthermore, the solution according to the invention also significantly reduces wear in the mixed friction region during starting and stopping. In addition, a mass moment of inertia of the rotor is reduced, as a result of which, given the same electrical design of an electric drive machine of the air supply unit, a critical rotational speed range is traversed more quickly during starting and stopping.

Exemplary embodiments of the invention are explained in more detail below with reference to drawings.

In particular:

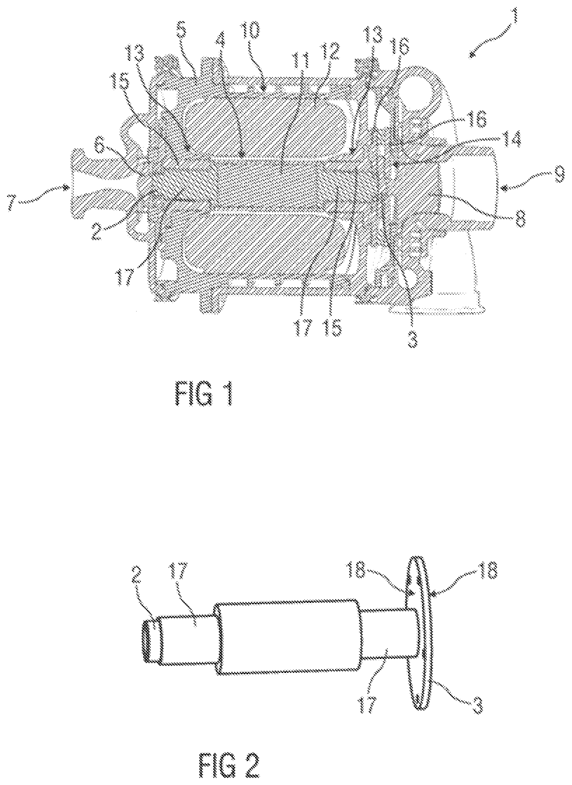

FIG. 1 schematically shows a sectional representation of an air supply unit for a fuel cell unit, and

FIG. 2 schematically shows a rotor shaft with an axial bearing disc of a rotor of the air supply unit from FIG. 1.

Parts corresponding to one another are provided with the same reference numerals in all the figures.

FIG. 1 shows a sectional representation of an air supply unit 1 for a fuel cell unit, not shown here, for example for a so-called fuel cell stack having a plurality of fuel cells. FIG. 2 shows a rotor shaft 2 with an axial bearing disc 3 of a rotor 4 of the air supply unit 1 from FIG. 1. In the example shown, the axial bearing disc 3 is fixedly connected, in particular non-rotatably connected, to the rotor shaft 2, but in other embodiments it can also be formed, for example, in one piece and/or integral with the rotor shaft 2.

The air supply unit 1 is designed analogously or similarly to an electric turbocharger for an internal combustion engine. It comprises a housing 5, in which the rotor 4 is rotatably mounted. The rotor 4 comprises a turbine wheel 6, which is arranged on an exhaust gas side 7 of the air supply unit 1, and a compressor wheel 8, which is arranged on a fresh air side 9 of the air supply unit 1.

The exhaust gas side 7 of the air supply unit 1 can be fluidically coupled or is actually coupled to an exhaust gas outlet of the fuel cell unit, so that the rotor 4 can be driven by exhaust gas of the fuel cell unit, which flows against and drives the turbine wheel 6. In order to assist the drive of the rotor 4, an electric drive machine 10 is also provided, in particular a permanent magnet synchronous motor (PMSM). The rotor 4 advantageously also forms a rotor 4 of this electric drive machine 10. For this purpose, in the illustrated example, it comprises at least one permanent magnet 11 or a plurality of permanent magnets 11 and is enclosed, at least in this permanent magnet region, by a stator 12 of the electric drive machine 10.

The fresh air side 9 of the air supply unit 1 can be fluidically coupled or is actually coupled to a fresh air inlet of the fuel cell unit, so that the air supply unit 1 can draw in fresh air, in particular from an external environment of the air supply unit 1, by means of its compressor wheel 8, compress the air and feed it to the fuel cell unit.

For the rotatable mounting of the rotor 4 in the housing 5, two radial bearings 13 and an axial bearing 14 are provided in the illustrated example. The bearing is advantageously achieved by means of foil-air bearings 15, 16, also referred to as air foil bearings, i.e. via air bearings which comprise one or more foils. For the respective radial bearing 13, therefore, one radial foil-air bearing 15 is provided in each case in the example shown, and for the axial bearing 14, two axial foil-air bearings 16 are provided in both axial directions of the rotor 4, in each case on one side of the axial bearing disc 3.

These air bearings are designed in particular as aerodynamic bearings, i.e. no compressed air supply is provided, but an air cushion supporting the rotor 4 forms in the case of a sufficiently fast rotational movement, i.e. in the case of a sufficiently high rotational speed, of the rotor 4. For this purpose, the foils are advantageously structured accordingly in order to achieve this aerodynamic effect.

The air bearings, in particular the foil-air bearings 15, 16, are used for air supply units 1 for fuel cell units, in particular on account of the requirement that bearing systems of the air supply unit 1 must not be provided with carbon-based lubricants, since otherwise there is the risk that the carbon-based lubricants can get into a membrane of a respective fuel cell of the fuel cell unit as a result of leaks, which would result in a reduced service life and a power loss of the fuel cell unit.

The problem with these air bearings, in particular with foil-air bearings 15, 16, is in particular the starting and stopping of the rotor 4 and an emergency operation, since for the above-described function they require a minimum circumferential speed for building up the supporting air gap and thus of the supporting air cushion and in these operating states the rotational speed of the rotor 4 and thus its circumferential speed is not yet sufficiently large or no longer sufficiently large. In other words, no air cushion is formed between the rotating rotor 4 and the respective foil, which is connected to a respective housing bearing portion and thus does not move. This creates friction, for example static friction when starting the rotor 4 from a standstill, for example sliding friction until forming the air cushion and/or for example mixed friction. Thus, the bearing systems, in the example shown the radial bearings 13 and the axial bearing 14, are subject to high solicitations, in particular when starting and stopping the rotor 4, which can lead to increased wear and to a high risk of failure.

In order to solve this problem and to improve the friction properties, the solution described in more detail below provides for the use of one or more carbon graphite materials and/or one or more resin-bonded carbon fiber materials, in particular in order to significantly increase the mixed friction properties and emergency running properties, in particular in the case of foil-air bearings 15, 16, in particular in the case of the radial bearings 13 and the axial bearing 14.

Carbon graphite materials and resin-bound carbon fiber materials have self-lubricating properties due to their particular crystal structure. Without additional lubricants, a coefficient of friction between such carbon materials and their friction partners is therefore comparatively small.

Due to the corresponding low friction coefficients, a material pairing with one or more of these carbon graphite materials and/or resin-bonded carbon fiber materials as a friction partner offers particularly good emergency running properties for these bearings, in particular foil-air bearings 15, 16, in particular in the case of metal alloys commonly used as the other friction partners for the respective foil. Furthermore, this also significantly reduces wear in the mixed friction region during starting and stopping of machines, here the air supply unit 1, with foil-air bearings 15, 16 of this type. This solution thus allows for an increase of the robustness of the air supply unit 1 by better mixed friction properties and emergency running properties of the foil-air bearings 15, 16, in particular of the radial bearings 13 and the axial bearing 14. In addition, a mass moment of inertia of the rotor 4 is reduced, as a result of which, given the same electrical design of the electric drive machine 10, the critical speed range is traversed more quickly during starting and stopping, in which no supporting air cushion is present.

The mentioned conventionally used metal alloys for such bearings, in particular foil-air bearings 15, 16, in particular for the respective foil, are, for example, steel, titanium or titanium alloys, also referred to as titanium, or nickel-based alloys having nickel as main component, chromium as important secondary component and optionally iron, molybdenum, niobium, cobalt, manganese, copper, aluminum, titanium, silicon, carbon, sulfur, phosphorus and/or boron as further secondary components. These nickel-based alloys are also referred to as Inconel.

In the solution described here, it is thus provided that one or more carbon graphite materials and/or one or more synthetic resin-bonded carbon fiber materials are used for the bearing of the rotor 4 in the housing 5, in particular as one of two friction partners of the respective bearing 13, 14.

In the air supply unit 1 shown here, the friction partners of the two radial bearings 13 are formed by the rotor shaft 2, in particular a respective radial bearing portion 17 of the rotor shaft 2 of the rotor 4, on the one hand, and at least one foil of the respective radial foil-air bearing 15, on the other hand. The respective radial foil-air bearing 15, in particular the respective foil, is in this case arranged between the rotor shaft 2, in particular the respective radial bearing portion 17, and a respective housing radial bearing portion of the housing 5 and is in particular fixedly connected to this housing radial bearing portion, with the result that a relative movement takes place between the rotor shaft 2 and the foil, but no relative movement between the housing radial bearing portion and the foil.

The friction partners of the axial bearing 14 are formed by the axial bearing disc 3, on the one hand, in particular by opposite bearing surfaces 18 of the axial bearing disc 3, and at least one foil of the respective axial foil-air bearing 16, on the other hand. The respective axial foil-air bearing 16, in particular the respective foil, is in this case arranged between the respective bearing surface 18 of the axial bearing disc 3 and a respective housing axial bearing portion of the housing 5 and is in particular fixedly connected to this housing axial bearing portion, so that a relative movement between the axial bearing disc 3, in particular the respective bearing surface 18, and the foil takes place, however, no relative movement takes place between the housing axial bearing portion and the foil.

As already mentioned above, it is advantageously provided that the foils of the foil-air bearings 15, 16 which form the one friction partner of the respective bearing 13, 14 are formed in a known manner, in particular from one of the metal alloys which are normally used for this purpose and are mentioned above by way of example. It is therefore provided that the respective other friction partner is formed of or coated with at least one of the abovementioned materials. In the example shown, this therefore relates to the rotor 4, in particular one or more portions of the rotor 4, in particular the rotor shaft 2, in particular the respective radial bearing portion 17 thereof, and the axial bearing disc 3, in particular the bearing surfaces 18 thereof.

Thus, in the rotor 4, which is rotatably mounted in the housing 5 of the air supply unit 1 for the fuel cell unit shown by way of example in FIG. 1, in particular by means of foil-air bearings 15, 16, it is advantageously provided that at least portions of the rotor 4 or the entire rotor are formed from at least one of the abovementioned materials, i.e. from at least one carbon graphite material and/or from at least one synthetic resin-bonded carbon fiber material, and/or that these portions are coated therewith. In particular, the rotor shaft 2, in particular its respective radial bearing portion 17, and/or the axial bearing disc 3, in particular its respective bearing surface 18, is formed at least in portions or entirely from at least one carbon graphite material and/or from at least one synthetic resin-bonded carbon fiber material and/or is coated therewith at least in portions.

For example, a combination of one or more carbon graphite materials and/or one or more resin-bonded carbon fiber materials can also be provided for the rotor 4. In particular in the case of coating, it can also be provided, for example, that different bearing portions are coated with different ones of the above-mentioned materials. For example, it can be provided that the radial bearing portions 17 and the axial bearing disc 3, in particular the bearing surfaces 18 thereof, are coated with different ones of the materials mentioned above, i.e. they have coatings that differ from one another. In the rotor shaft 2, it can be provided, for example, that all radial bearing portions 17 are coated with the same material or with different ones of the above-mentioned materials. In the case of the axial bearing disc 3, for example, it is provided that both bearing surfaces 18 are coated with the same material or with different ones of the above-mentioned materials.

Also, in the case of the embodiment formed from one of the above-mentioned materials, it can be provided that the rotor shaft 2 and the axial bearing disc 3, in portions or in their entirety, are formed of the same material or from different ones of the above-mentioned materials.

It can also be provided, for example, that the rotor shaft 2 is formed at least in portions or entirely from at least one of the above-mentioned materials and the axial bearing disc 3 is coated at least in portions or entirely with at least one of the above-mentioned materials, or that the rotor shaft 2 is coated at least in portions or entirely with at least one of the above-mentioned materials and the axial bearing disc 3 is formed at least in portions or entirely from at least one of the above-mentioned materials.

### LIST OF REFERENCE NUMERALS

1 air supply unit

2 rotor shaft

3 axial bearing washer

4 rotors

5 housing

6 turbine wheel

7 exhaust gas side

8 compressor wheel

9 fresh air side

10 electric drive machine

11 permanent magnet

12 stator

13 radial bearings

14 axial bearing

15 radial foil-air bearings

16 axial foil-air bearings

17 radial bearing portion

18 bearing surface

1. A rotor for an air supply unit of a fuel cell unit, which rotor is provided to be rotatably mounted in a housing of the air supply unit by means of foil-air bearings,
wherein
at least portions of the rotor are formed of a carbon graphite material or of a synthetic-resin-bonded carbon fiber material or are coated therewith.

2. The rotor of claim 1,
wherein
at least portions of a rotor shaft and/or of an axial bearing disc of the rotor are formed of the carbon graphite material or of the synthetic resin-bonded carbon fiber material or are coated therewith.

3. The rotor of claim 2,
wherein
the rotor shaft has two radial bearing portions, which are each formed of the carbon-graphite material or of the synthetic resin-bonded carbon fiber material or are coated therewith.

4. The rotor of claim 2,
wherein
opposite bearing surfaces of the axial bearing disc are coated with the carbon-graphite material or with the synthetic resin-bonded carbon fiber material.

5. An air supply unit for a fuel cell unit, wherein the air supply unit comprises a rotor of claim 1, which rotor is rotatably mounted in a housing of the air supply unit by means of foil-air bearings.

6. The rotor of claim 3, wherein
opposite bearing surfaces of the axial bearing disc are coated with the carbon-graphite material or with the synthetic resin-bonded carbon fiber material.

7. An air supply unit for a fuel cell unit, wherein the air supply unit comprises a rotor of claim 2, which rotor is rotatably mounted in a housing of the air supply unit by means of foil-air bearings.

8. An air supply unit for a fuel cell unit, wherein the air supply unit comprises a rotor of claim 3, which rotor is rotatably mounted in a housing of the air supply unit by means of foil-air bearings.

9. An air supply unit for a fuel cell unit, wherein the air supply unit comprises a rotor of claim 4, which rotor is rotatably mounted in a housing of the air supply unit by means of foil-air bearings.
